(19) United States
(12) Patent Application Publication
(10) Pub. No.: US 2005/0212819 A1
(43) Pub. Date: Sep. 29, 2005

(54) Image display method, image display apparatus and image display program

(75) Inventors: Masahiro Kubo, Kanagawa (JP); Takayuki Iida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/091,425

(22) Filed: Mar. 29, 2005

(30) Foreign Application Priority Data
Mar. 29, 2004 (JP) 2004-096907

(51) Int. Cl. H04N 17/02

(52) U.S. Cl. 345/619

(57) ABSTRACT

In a main display area of a second correction screen on a monitor, a floating window is displayed together with a target image to correct, at a position designated by placing a reference point on an appropriate point on the target image. The floating window is split into a plural number of partial display sections, wherein those portions of the target image which have similar colors to a color of the reference point are displayed as target components of color correction, in such conditions as corrected based on different color correction parameter values from one another between the partial display sections. When one of the partial display sections is selected, all of those portions of the target image which correspond to the target components are displayed in the same color-corrected conditions as those displayed in the selected partial display section.

### FIELD OF THE INVENTION

The present invention relates to a method of and an apparatus for displaying images on a monitor that is attached to a data processing terminal such as a personal computer, for processing electronic or digital images taken through a digital camera and the like. The present invention relates also to an image display program for these method and apparatus.

### BACKGROUND ARTS

With a personal computer or other kind of data processing terminal, digital images can be corrected in color-balance, tone curve or other characteristics, to improve their qualities. For example, image data taken through a digital camera are sent to the personal computer. Then, an operator may adjusts various kinds of correction parameters while observing images displayed on a monitor of the personal computer based on the image data, in order to finish images according to the operator's intension. In case of a digital camera that can output original or raw image data that is not subjected to white-balance correction or other image-processing, it is possible to correct images in the personal computer without missing any color data on the side of the digital camera.

As an efficient image correction method, Japanese Laid-open Patent Application No. Hei 11-136528 suggests displaying a number of sample images of the same content but corrected with different correction parameters, simultaneously on the monitor, to allow an operator to select one among those sample images while observing differences in correction result between the different correction parameters. Then, the image data is processed with the correction parameter corresponding to the selected sample image.

Since the above mentioned prior art displays the sample images separately from one another, the operators have to move their eyes widely and repeatedly to compare the sample images to each other, so it is difficult to differentiate between the correction results when the correction parameters are finely adjusted. But in those cases seeking high-quality images with special intentions, such as wedding shots, commercial shots and other studio shots, it is necessary to adjust the correction parameters finely and strictly.

Moreover, it is desirable to correct colors of each individual component of an image independently of other components. For example, it is desirable to correct the color of a face of a human subject independently of its clothes. However, according to the above prior art, any color correction has effect on the whole image, so it is difficult to correct the tinge of each individual image component to be optimum.

### SUMMARY OF THE INVENTION

In view of the foregoing, a primary object of the present invention is to provide an image display method, an image display apparatus and an image display program, which facilitate visual discrimination between correction results obtained by correcting a target image with different correction parameters, and also permits correcting a designated portion of the target image independently of other portions of the image.

In order to make it easy for the operator to discriminate between correction results obtained by correcting a designated portion with different correction parameter values, it is effective to display the correction results side by side on the same screen. Therefore, to achieve the above and other objects in an image display method of displaying a target image to correct in an image display area on a monitor, the method of the present invention comprises steps of displaying a split display window in the image display area simultaneously with the target image, the split display window comprising a plural number of partial display sections; and displaying substantially the same portion of the target image in the partial display sections in such conditions as corrected based on different color correction parameter values from one another between the partial display sections.

According to a preferred embodiment, a reference point is displayed movable on the target image in the image display area for designating the image portion to be displayed in the partial display sections. A definite range, of the target image, including the reference point, is displayed as the image portion in each of the partial display sections. The definite range is preferably defined by the size of each of the partial display sections, and the whole size of the split display window and individual sizes of the partial display sections within the split display window are changeable.

According to a preferred embodiment, those portions having similar colors to a color of a corresponding pixel to the reference point are extracted as target components of color correction from the target image, so that only the target components are displayed in color-corrected conditions in the partial display sections. More preferably, a component of the target image, which the pixel corresponding to the reference point belongs to, is determined to be the target component of the color-correction through a contour extraction process, so that only the determined target component is subjected to the color correction in the partial display sections. When one of the partial display sections is selected, all of those portions of the target image which correspond to the target components are revised into such conditions as corrected based on the color correction parameter values that are allocated to the selected partial display section.

An image display apparatus with a monitor for displaying a target image to correct in an image display area, the image display apparatus comprising a device for displaying a split display window in the image display area simultaneously with the target image, the split display window comprising a plural number of partial display sections; and a device for displaying substantially the same portion of the target image in the partial display sections in such conditions as corrected based on different color correction parameter values from one another between the partial display sections.

An image display program for activating a computer to work as a device for displaying a target image to correct in an image display area on a monitor, a device for displaying a split display window in the image display area simultaneously with the target image, the split display window comprising a plural number of partial display sections, a device for displaying substantially the same portion of the target image in the partial display sections in such conditions as corrected based on different color correction parameter values from one another between the partial display sections.

Because the correction results obtained by correcting substantially the same portion of the target image with different correction parameters are displayed in the partial display sections, it is easy to compare the correction results to each other.

According to the preferred embodiments, the operator can designate the target components of color correction just by placing the reference point of the split display window in an appropriate portion of the target image, and adjust the colors of only the target components just by selecting one of the partial display sections.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a block diagram schematically illustrating a digital camera and a personal computer for correcting images taken by the digital camera;

FIG. 2 is an explanatory diagram illustrating an example of a first correction screen;

FIG. 3 is an explanatory diagram illustrating an example of a second correction screen with a floating window;

FIG. 4 is a flowchart illustrating a sequence of displaying the floating window;

FIG. 5 is an explanatory diagram illustrating the second correction screen having the floating window changed in size of its display sections;

FIG. 6 is a fragmentary view of the second correction screen having the floating window moved from the position shown in FIG. 3;

FIG. 7 is a fragmentary view of the second correction screen displaying a second floating window in addition to the first floating window;

FIG. 8 is a fragmentary view of the second correction screen in a condition where one of the display sections is chosen in each of the floating windows;

FIG. 9 is an explanatory diagram illustrating the first correction screen displaying a result of color correction done by use of the floating window;

FIG. 10 is a fragmentary view of the second correction screen in a condition where the display sections are relocated within the floating window;

FIG. 11 is a fragmentary view of the second correction screen in a condition where a chosen one of the display sections of the floating window is displayed in continuation to an target image, immediately after it is chosen;

FIG. 12 is a fragmentary view of the second correction screen, illustrating another example of floating window where a reference point is located inside the window; and

FIG. 13 is a fragmentary view of the second correction screen, illustrating still another example of floating window.

### DESCRIPTION OF THE PREFERRED EMBODIMENTS

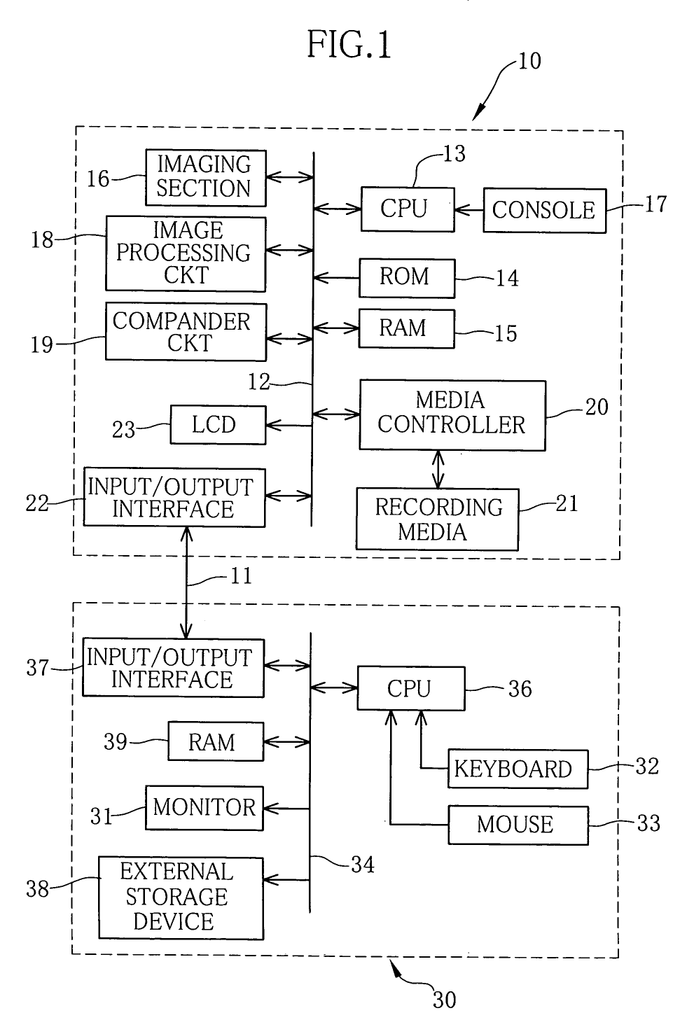

In FIG. 1, a digital camera 10 and a personal computer (PC) 30 are connected to each other through a communication cable 11, so that they may send and receive camera control data and image data between each other. The image correcting PC 30 may be a commercially available personal computer insofar as it is installed with an image correction program including an image display program of the present invention. The communication cable 11 may be of USB (Universal Serial Bus) type or IEEE1394 type. Instead of the communication cable 11, a radio communication device is usable for data communication between the digital camera 10 and the image correcting PC 30.

All components of the digital camera 10 are connected to each other through a data bus 12, and their operations are controlled comprehensively by a CPU 13. A ROM 14 stores programs necessary for the operation of the digital camera 10, and some of the programs are loaded in a RAM 15 according to the needs. An imaging section 16 is provided with an image forming lens, a CCD and other well-known members for photoelectric conversion of an optical image of a subject into digital image data. Imaging conditions, including an aperture value and a shutter speed, are set up by operating a console 17 with many setup buttons. It is also possible to designate the imaging conditions on the image correcting PC 30, and send data of the designated imaging conditions to the digital camera 10 to set the digital camera 10 in these conditions. It is alternatively possible to connect another personal computer to the digital camera 10, to control the digital camera 10 through this personal computer.

The image data output from the imaging section 16 is temporarily stored in the RAM 15. The image data stored in the RAM 15 is raw image data before going through image processing like white-balance correction, and consists of a large number of 12-bit pixel data representative of a tone level for each of three primary colors. An image processing circuit 18 processes the raw image data to convert the 12-bit pixel data of each color into 8-bit data, correct white-balance and convert gradation in accordance with predetermined conditions for respective camera types. A compander circuit 19 compresses the processed image data according to JPEG (Joint Photographic Coding Expert Group) format, and outputs the compressed image data. The compander circuit 19 also subjects the processed image data to a decimation for producing JPEG thumbnail image data of 1280×960 pixels.

The raw image data or the compressed image data is sent together with the thumbnail image data to the image correcting PC 30 via an input/output interface 22. An LCD 23 displays images of subjects continuously during a camera mode, and also displays images recorded on a removable recording medium 21 during a reproduction mode.

Whether the digital camera 10 outputs the raw image data or the compressed image data is decided with other camera conditions. It is also possible to output both the raw image data and the compressed image data. The present embodiment will be described with respect to a case where the digital camera 10 outputs the raw image data and the thumbnail image data. Furthermore, the raw image data may be transferred to the image correcting PC 30 by recording it on the recording medium 21 and setting the recording medium 21 in the image correcting PC 30, though the raw image data is sent through the communication cable 11 to the image correcting PC 30 in the following embodiment.

The image correcting PC 30 reproduces images based on the raw image data and displays the reproduced images on a monitor 31. The image correcting PC 30 also carries out different kinds of image correction in accordance with signals entered through input devices such as a keyboard 32 and a mouse 33. All components of the image correcting PC 30 are connected to each other through a data bus 34, and their operations are controlled comprehensively by a CPU. The image data received from the digital camera 10 is written on an external storage device 38 via an input/output interface 37 and the data bus 34. In a case where the image correcting PC 30 is used for controlling the digital camera 10, the input devices, including the keyboard 32 and the mouse 33, are operated for designating the camera conditions as well as for the image correction.

The image correction program is installed in the external storage device 38 of the image correcting PC 30 via a recording medium like CD-ROM or DVD-ROM, or the Internet or the like. When a command to execute the image correction program is entered through the keyboard 32 or the mouse 33, the image correction program is loaded in the RAM 39. With the execution of the image correction program, the monitor 31 displays a list of thumbnails corresponding to the raw image data written on the external storage device 38.

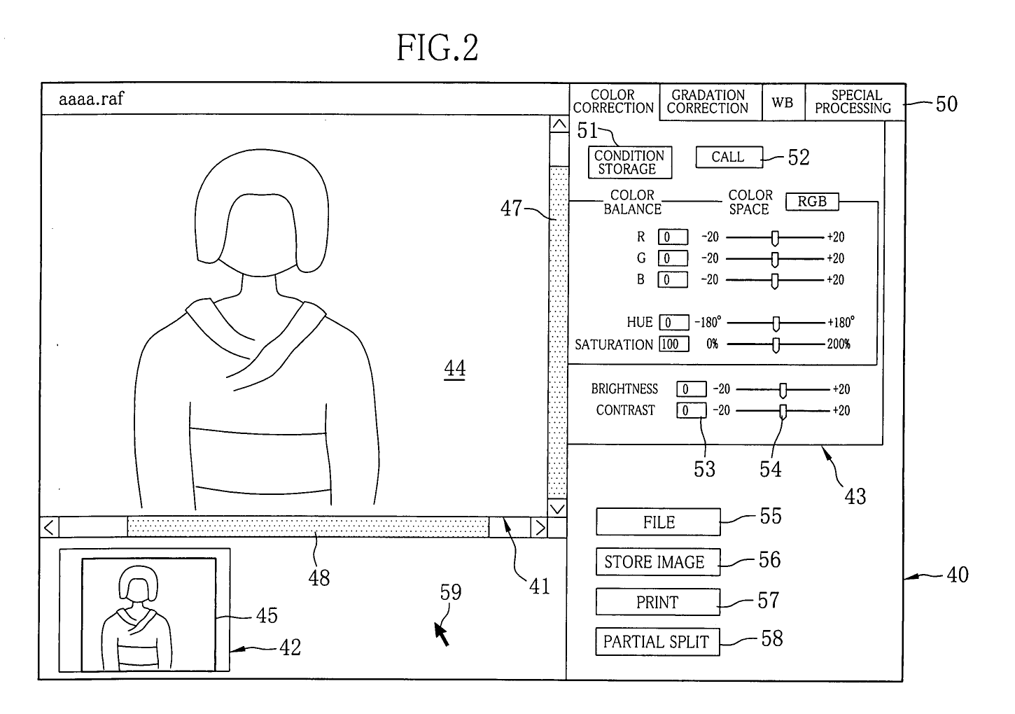

When the operator designates an image to correct, or called a target image, among the thumbnails by operating the keyboard 32 or the mouse 33, the raw image data of the designated target image is read out from the external storage device 38 and written in the RAM 39. Then, format of the raw image data is converted into a suitable one for displaying the designated image in a first correction screen 40 on the monitor 31, as shown in FIG. 2, in accordance with default conditions predetermined by the image correction program. For example, the raw image data is converted into Tiff (Tagged Image File Format) data having 16-bit tonal levels for each color.

As FIG. 2 shows, the first correction screen 40 consists of a main display area 41 and a sub display area 42 and a parameter adjusting area 43. The main display area 41 displays an image 44 that is selected to be corrected, of which correction parameters like white-balance and gradation may be changed by operating the keyboard 32 or the mouse 33. Then the raw image data of the selected image to correct 44, or called the target image, is corrected with the changed values of the correction parameters, and image display data is produced again from the corrected image data. Thereby, the image displayed in the main display area 41 reflects the change in the correction parameters. Hereinafter, the process of correcting the raw image data and outputting it as image display data for displaying an image on the monitor 31 will be referred to as “visualizing process”.

The sub display area 42 displays the whole target image 44 in a reduced size. The sub display area 42 is provided with a rectangular frame 45 confining the range of the target image 44 to be displayed in the main display area 41. The rectangular frame 45 may change its position and size within the sub display area 42, to change the displayed range of the target image 44 on the main display area 41. The range of the target image 44 displayed on the main display area 41 may also be changed by moving scroll bars 47 and 48 which are provided on a right side and a bottom side of the main display area 41.

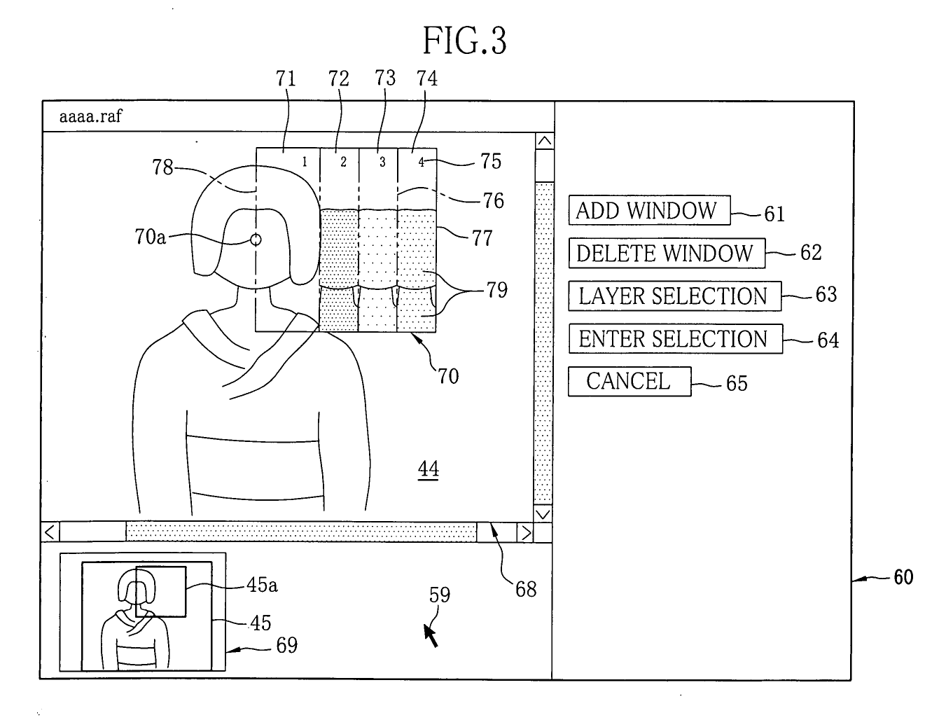

The parameter adjusting area 43 is provided with four types of adjusting screens for color correction, gradation correction, white balance (WB) correction and special effect, which are switched over from one another by selecting one of switching tabs 50 provided in an upper position of the parameter adjusting area 43. If the tab for color correction is selected, as shown in FIG. 3, an adjusting screen for the color correction is displayed in the parameter adjusting area 43, whereby color balance including balance between three primary colors R, G and B, color hue and saturation, brightness, contrast and other parameters may be adjusted.

Below the switching tabs 50 are disposed a condition storage button 51 and a call button 52. When a cursor 59 is clicked on the condition storage button 51 by operating the mouse 33, a correction condition file containing current values of the correction parameters is stored under an appropriate name. When the cursor 59 is clicked on the call button 52, a list of stored correction condition files are displayed. By selecting one of the stored correction condition files, the raw image data of the target image 44 is subjected to the visualizing process with the correction parameter values contained in the selected correction condition file, so that the main display area 41 displays the image in the conditions corrected in correspondence with the selected correction condition file. Therefore, in order to correct the image in the same way as a previously corrected image, the operator has only to read out the correction condition file used for the previously corrected image. The operator may thereafter carry out fine-adjustment on the corrected image. Therefore, the image may be corrected efficiently.

In a center portion of the parameter adjusting area 43 are displayed respective values of the correction parameters such as the color balance, brightness and contrast. The values of the correction parameters may be changed by entering a numerical value directly in each of data input boxes 53 that are provided for the respective correction parameters, or by shifting indicators 54 left and right in the drawings. With a change in any of the correction parameters, the raw image data corresponding to the target image 44 is visualized with the changed correction values, to display the correspondingly corrected image in the main display area 41.

If the tab for gradation correction is selected, an adjusting screen for the gradation correction is displayed in the parameter adjusting area 43, whereby tone curve and gamma value may be adjusted. If the tab for white-balance correction is selected, density histograms for respective basic colors are displayed, and parameters for light source and color temperature may be adjusted. If the tab for the special effect is selected, parameters for hyper-tone processing or hyper-sharpness processing may be adjusted.

Below the parameter adjusting area 43 are displayed buttons 55, 56, 57 and 58 for inputting various commands. When the cursor 59 is clicked on the “file” button 55, thumbnails corresponding to the raw image data stored in the external storage device 38 are displayed as a list on the monitor 31, enabling choosing a target image on the list. When the cursor 59 is clicked on the “store image” button 56, the image displayed on the main display area 41 is output as a file. When the cursor 59 is clicked on the “print” button 57, the image displayed on the main display area 41 is printed out as a hard copy. It is of course possible to display other buttons or icons for inputting other kinds of commands.

When the cursor 59 is clicked on the “partial split” button 58, the personal computer 30 is switched to a partial split display mode, so the monitor 31 displays a second correction screen 60 that permits correcting an appropriate portion of the target image 44, as shown in FIG. 3. The second correction screen 60 is provided with a main display area 68 and a sub display area 69, like the first correction screen 40. On right hand side of the main display area 68 are displayed buttons 61, 62, 63, 64 and 65 for inputting various commands.

In the main display area 68 of the second correction screen 60 is displayed a split display window or floating window 70, overlapping the target image 44 as selected on the first correction screen 40. In the example shown in FIG. 3, the floating window 70 is split into four adjoining display sections 71, 72, 73 and 74, so the display sections 71 to 74 display substantially the same portion of the target image 44 in conditions corrected with different color correction parameter values from each other. Section numbers 75 are displayed in the respective display sections 71, 72, 73 and 74 as identification numbers of these sections. But it is not always necessary to display the section numbers 75.

The display sections 71 to 74 of the floating window 70 are adjacent to one another, as borders between them being shown by phantom lines 76, but these phantom lines are just for illustrative sake and actually not displayed on the second correction screen 60. An outline 77 of the floating window 70 may be displayed by a solid line, but it is not always necessary to display the outline 77 on the second correction screen 60. However, among the four sides of the outline 77, it is preferable not to display the border line 78 on the left side of the first display section 71, because the image portion displayed in the first display section 71 continues to other image portions which are displayed outside the floating window 70.

The image portions displayed in the first to fourth display sections 71 to 74 are corrected their colors with different correction parameter values from each other. Correspondingly, image display data for displaying these image portions differ from each other. The first display section 71 is located on the leftmost position in the floating window 70, and displays the target image 44 in its initial condition. A center point of the border line 78 is defined as a reference point 70a. The image portion to be displayed in each of the second to fourth display sections 72 to 74 is a portion that has the reference point 70a at the center and is defined by the width and length of each of these display sections 72 to 74. In the example of FIG. 3, the second to fourth display sections 72 to 74 have the same width and length, so they display the same portion of the target image 44 based on the different image display data as corrected with predetermined different color correction parameter values from each other.

More particularly, the second to fourth display sections 72 to 74 display only those image portions 79 whose colors belong to the same color tone range as the color at the reference point 70a. Hereinafter, such image portions 79 will be referred to as the target component of color correction. In the example shown in FIG. 3, the reference point 70a is placed in a face of a human subject, so the face and a neck of the human subject as having similar colors to the color at the reference point 70a are displayed fragmentarily in each of the second to fourth display sections 72 to 74. Concretely, a color tone range is defined to cover a constant width around RGB tonal levels of a pixel that corresponds to the reference point 70a, and those pixels whose RGB tonal levels belong to the defined color tone range are extracted from the image display data for the second to fourth display sections 72 to 74.

On the floating window 70, the sub display area 69 displays a sub frame 45a for indicating a display range of the floating window 70 besides the above-mentioned frame 45. The sub frame 45a may change in position and size within the sub display area 69, to change the position or the size of the floating window 70 in the main display area 68. Instead of the sub frame 45a, the floating window 70 itself may be dragged and dropped to move its position by operating the mouse 33.

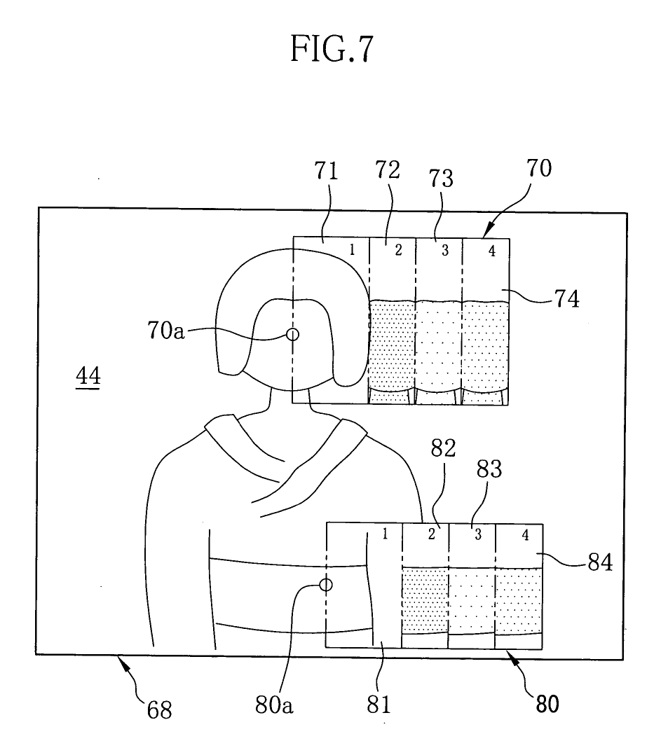

“Add Window” button 61 is for displaying another floating window 80 (see FIG. 7) in addition to the floating window 70. “Delete Window” button 62 is for deleting a designated floating window. “Layer Selection” button 63 is for selecting one of the display sections 71 to 74 of the floating window 70. Then, the correction result of the selected display section is reflected on the whole image. “Enter Selection” button 64 is for returning to the first correction screen 40, displaying the image in the condition corresponding to the selected display section. On the contrary, when “Cancel” button 65 is operated, the monitor 31 returns to the first correction screen 40, but displaying the target image 44 in the initial condition without reflecting any correction results.

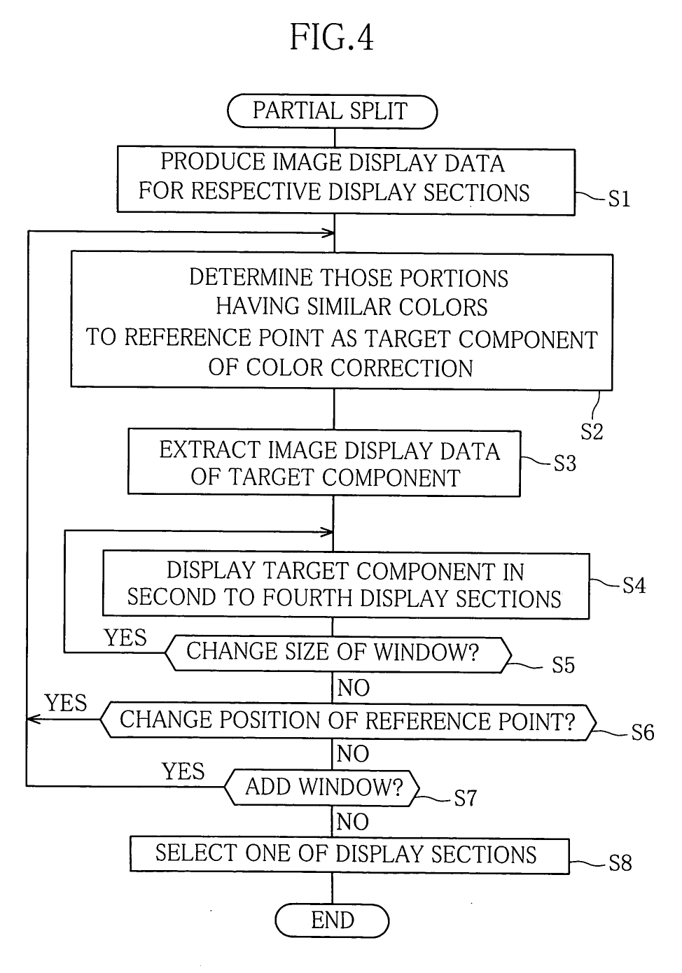

Now the operation in the partial split display mode will be described with reference to the flowchart of FIG. 4.

When the partial split button 58 is selected by clicking on the first correction screen 40, copies of image display data of the target image 44, which has already been written on the RAM 39 to display the target image 44 on the first correction screen 40, are developed in the RAM 39. Then, each copy is corrected with different color correction parameter values, to produce different image display data for the second to fourth display sections 72 to 74 (step 1=S1 in FIG. 4). The image display data for the target image 44 may directly serve as image display data for the first display section 71.

Next, based on RGB tonal levels of a pixel corresponding to the reference point 70a, those portions having similar colors to the reference point 70a are extracted as the target component of color correction from the target image 44 (step 2). Then, pixels corresponding to the target component of color correction are read out from the respective image display data for the second to fourth display sections (step 3). Thereafter, according to the width and length of each of the second to fourth display sections 72 to 74 of the floating window 70, a fragment of the target component of color correction is cut out to be displayed in each display section 72, 73 or 74 (step 4).

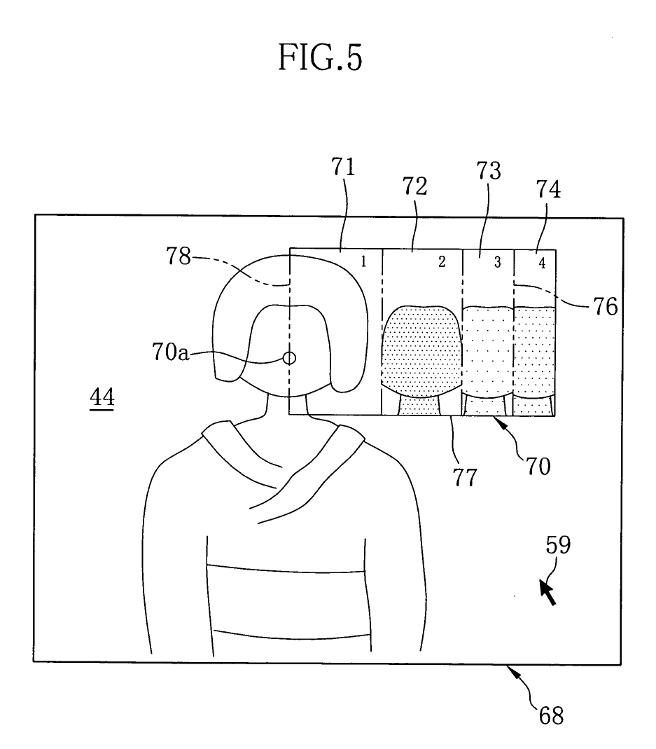

While observing the image portions displayed in the display sections 72 to 74 in comparison with the image portion in the first display section 71 on the second correction screen 60, the operator may select a favorite one among these. It is possible to change the width of the individual display section or the size of the floating window 70, as shown for example in FIG. 5, by dragging a particular part of the outline 77 or the border lines 76. If the width of any display section or the whole size of the floating window 70 is changed, i.e. if the answer is YES in step 5 of the flowchart of FIG. 4, the size or display range of each fragment of the target component of color correction is revised correspondingly. It is to be noted that FIGS. 5 to 8 and FIG. 10 to 13 show only the main display area 68 of the second correction screen 60, for the clarity sake.

When the floating window 70 is moved, the position of the reference point 70a moves correspondingly, that is, when the answer is YES in step 6 of the flowchart. Then, those portions having similar colors to a color of the new reference point 70a are determined as a new target component of color correction, so image portions displayed in the display sections 71 to 74 are revised (steps 2 to 4).

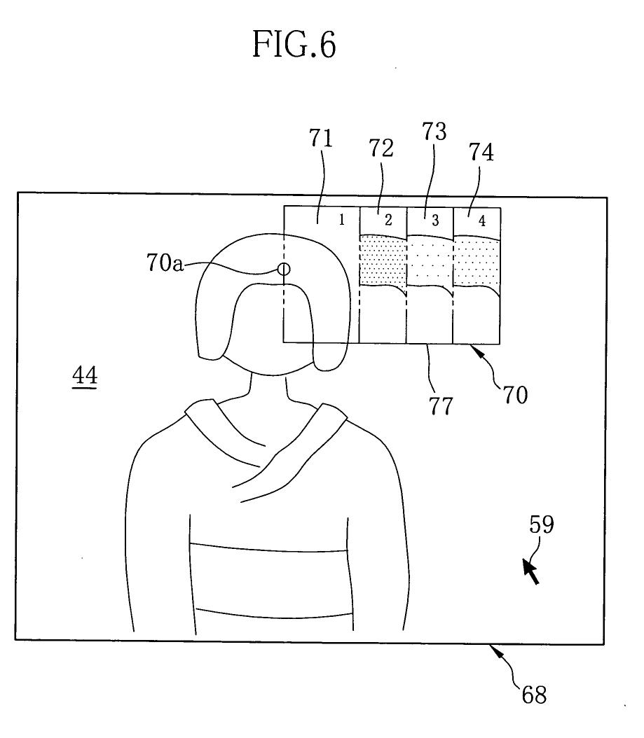

As shown for example in FIG. 6, if the reference point 70a is moved on the hair of the human subject, the hair of the human subject is determined as the new target component of color correction. In that case, the second to fourth display sections 72 to 74 display the hair in place of the face.

When a command for displaying another floating window is entered by clicking on the “Add Window” button 61, or by operating the mouse 33 or the keyboard 32 correspondingly, that is, when the answer is YES in step 6, the second floating window 80 is displayed in the main display area 68 in addition to the first floating window 70, as shown in FIG. 7. Thereafter when the operator locates a second reference point 80a at an appropriate position of the target image 44, those portions having similar colors to a color of the second reference point 80a are extracted as target components of color correction, to be displayed in display sections 81, 82, 83 and 84. In the example of FIG. 7, a girdle of the human subject is determined to be the target component, and is fragmentarily displayed in the second to fourth display sections 82 to 84 in conditions corrected differently from one another, as well as from that displayed in the first display section 81.

Image display data for displaying the target component in the second to fourth display sections 82 to 84 may be extracted respectively from the image display data already produced for the second to fourth display sections 72 to 74 of the first floating window 70. It is alternatively possible to produce the image display data for the second floating window 80 separately from those for the first floating window 70.

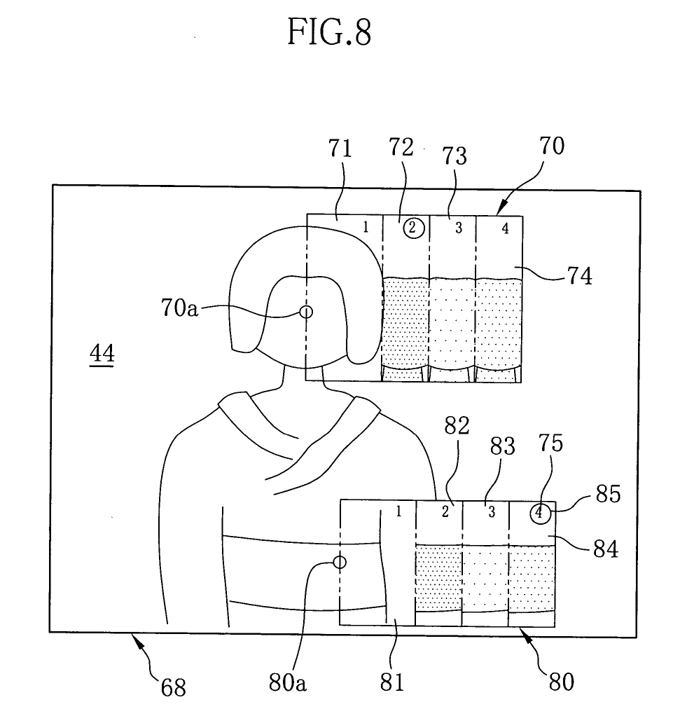

While observing the second correction screen 60, the operator may select favorite ones from among the display sections 71 to 74 of the first floating window 70 and one from among the display sections 81 to 84 of the second floating window 80 (step 8). As one of the display sections is selected, an indicator 85 is displayed around the section number 75 of the selected display section. In the example shown in FIG. 8, the second display section 72 is selected in the first floating window 70, whereas the fourth display section 84 is selected in the second floating window 80.

The indicator 85 is circular in the illustrated example, but it may be rectangular, triangular, or of another shape. In a case where the section numbers 75 are not displayed, a highlight bar may be displayed in connection to the selected display section, to indicate the selected display section.

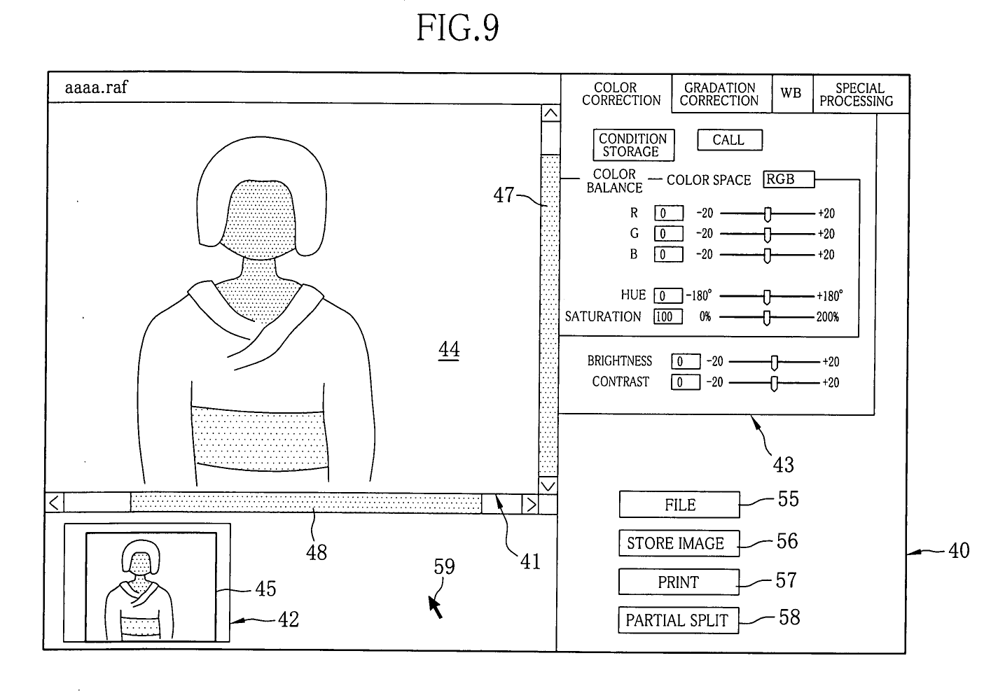

When the selection of the display sections is completed by clicking on the “Enter Selection” button 64, the first correction screen 40 is displayed again as shown in FIG. 9, but the target image 44 displayed now on the first correction screen 40 reflects the correction results of the fine-adjustment of color tones that is done on the second correction screen 60.

As described so far, since the display sections 71 to 74 of the floating window 70 display substantially the same image portions of the target image 44 side by side in conditions corrected with finely adjusted color correction parameter values, and the image portion to correct may be designated by the reference point 70a, the operator can adjust the color of an appropriate portion of the image separately from other portions. Accordingly, the operator can correct the image roughly on the first correction screen 40, and then has the second correction screen 60 displayed for fine-adjustment. When the floating window 70 is located at an appropriate image portion that the operator wants to correct. The corresponding target component of color correction is displayed in each of the display sections 71 to 74 in differently corrected conditions from each other. So the operator can carry out fine-adjustment of the color of the target component just by selecting a favorite one from among the several display sections 71 to 74. Since the display sections 71 to 74 are displayed inside the same floating window 70, the operator can easily see the difference between the correction results obtained by changing the color correction parameter values, without the need for widely moving the eyes. So the work efficiency of image correction is highly improved.

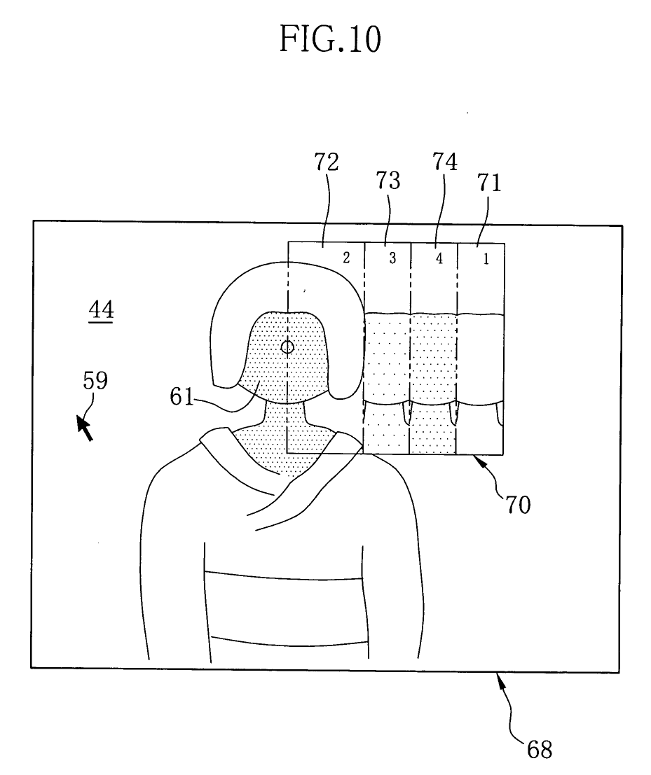

The display sections 71 to 74 may be rearranged in the floating window 70, as shown for example in FIG. 10. In the example of FIG. 10, the second display section 72 is located on the leftmost position, while the first display section 71 is located on the rightmost position. The rearrangement of the display sections may be done by dragging an appropriate one to an appropriate position, or by use of shift buttons that are not shown but may be provided on the second correction screen 60. As described above, the first display section 71 displays the image in the same condition as in the main display area 41 of the second correction screen 60, so the first display section 71 can be regarded as a referential display section. It is possible to provide a plural number of such referential display sections, and arrange the referential display sections to border on other display sections respectively.

In the example of FIG. 10, the image portion displayed in the rearranged second display section 72 continues to other portions of the target image 44, like as the image portion in the first display section 71 before the rearrangement. Since the color of the target component, i.e. the face and neck of the human subject in this example, is corrected to be different from the initial condition in the second display section 72, it is preferable to display the whole target component in the same condition as in the second display section 72.

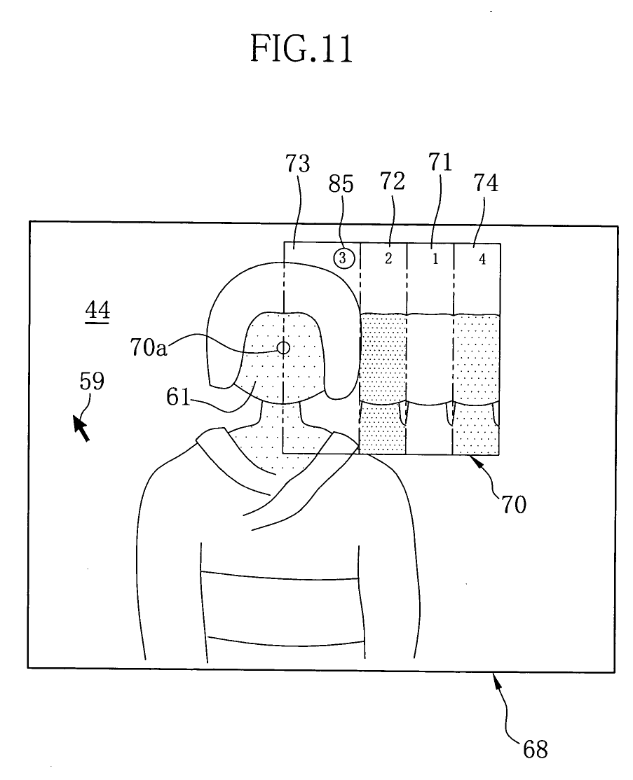

It is also preferable to shift the selected one of the display sections 71 to 74 automatically to the position having the reference point 70a of the floating window 70, so that the selected display section, e.g. the third display section 73 in FIG. 11, displays the target component in continuation to other portions of the target image 44. This embodiment makes it easier for the operator to confirm the selected correction result of the target component without returning to the first correction screen 40. The same as described with respect to the first floating window 70 applies to the second floating window 80.

In the above embodiments, those portions having similar colors to the color of the reference point 70a or 80a are determined as the target component of color correction. As an alternative, a contour extraction process may be used for determining the target component of color correction, whereby only those pixels belonging to the same image portion as the pixel at the reference point 70a or 80a are extracted for color correction. In other words, in the example shown in FIG. 3, only the face of the human subject is defined as the target component of color correction, while the neck is excluded from the target component. Thus, the color correction may be carried out while defining the target component more specifically.

The contour extraction process may be done for example according to a method disclosed in Japanese Laid-open Patent Application No. 6-233076, wherein a reference range is defined around RGB tonal levels of the pixel that corresponds to the reference point 70a or 80a, and image data are retrieved sequentially from those pixels arranged in a retrieval direction from the pixel of the reference point 70a or 80a, to check if the RGB tonal levels of these image data are within the reference range. Those pixels having the RGB tonal levels within the reference range are regarded as belonging to the same portion as the reference point 70a or 80a. If the RGB tonal levels of one pixel is within the reference range and those of the next pixel exceed the reference range, the former pixel is judged to constitute a contour. After one pixel constituting the contour is detected, the retrieval direction is shifted by 90 degrees, and the same operation is carried out till another pixel constituting the contour is determined. By repeating this operation, the whole contour of the target component is extracted.

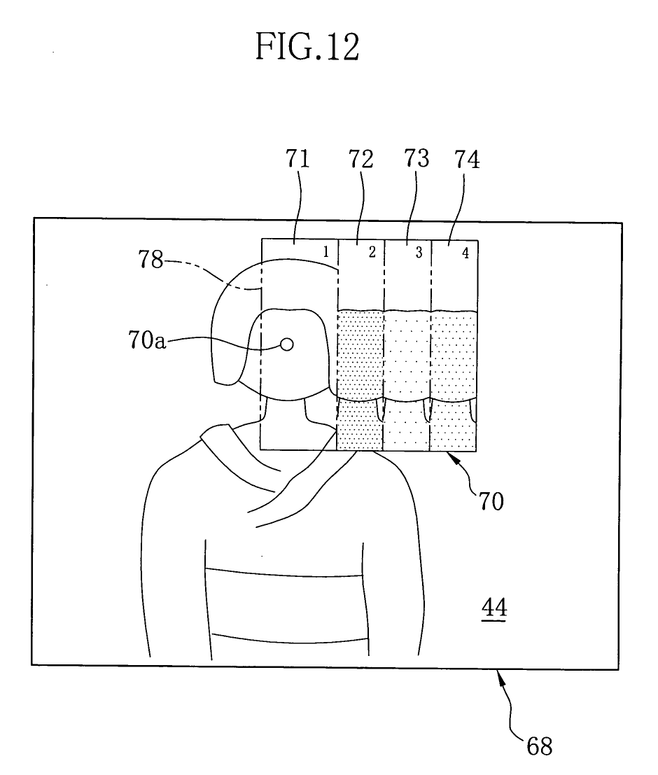

Although the reference point 70a is located on the phantom line 78 of the floating window 70 in the above embodiments, it is not always necessary to locate the reference point 70a on the border of the floating window 70. The reference point 70a may be located inside the floating window 70, as shown in FIG. 12. It is alternatively possible to make the reference point 70a movable inside the floating window 70.

According to the above embodiments, the image portion displayed in each of the display sections 72 to 74 is a portion that has the reference point 70a at the center and is defined by the width and length of each of these display sections 72 to 74. But the definition of the image portion to be displayed in the display sections 72 to 74 is not limited to this embodiment. It is not always necessary to define the reference point 70a as the center of the image portion in the display section of the floating window, but the display sections 72 to 74 may display a certain range of the target image, including those pixels corresponding to the reference point 70a.

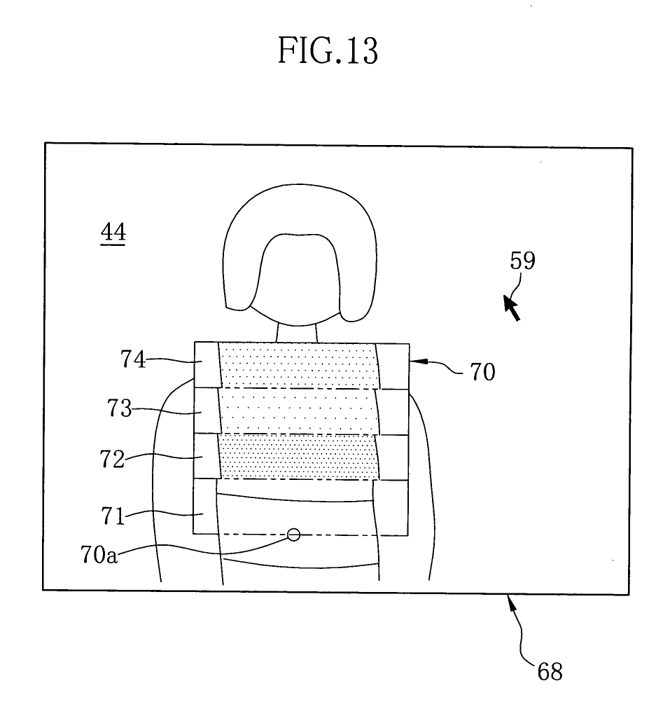

Although the display sections 71 to 74 of the floating window 70 are arranged side by side from the left to the right in the drawings, it is possible to arrange them atop another as shown for example in FIG. 13.

In the above embodiments, the image portions displayed in the display sections 72 to 74 of the floating window 70 are automatically color-corrected. But it is alternatively or additionally possible that the operator corrects or adjusts the color of the target component in each of the display sections 72 to 74.

In the above embodiment, the image correcting personal computer is constituted of a general purpose computer installed with the image correction program. But a specific computer mounted with the image correcting circuit and the image processing circuit is usable as the image correcting personal computer.

Although the present invention has been described with respect to the embodiment where the raw image data is subjected to the image correction and, thereafter, converted into the image display data, the present invention is applicable to those cases where the image display data, e.g. Tiff data, bit-mapped data or JPEG data, is subjected to the image correction to display the corrected image.

Thus, the present invention is not to be limited to the above-described embodiments but, on the contrary, various modifications will be possible without departing from the scope of claims appended hereto.

1. An image display method of displaying a target image to correct in an image display area on a monitor, said method comprising steps of:
displaying a split display window in said image display area simultaneously with said target image, said split display window comprising a plural number of partial display sections; and
displaying substantially the same portion of said target image in said partial display sections in such conditions as corrected based on different color correction parameter values from one another between said partial display sections.

2. An image display method as claimed in claim 1, further comprising a step of displaying a reference point for designating said image portion to be displayed in said partial display sections, such that said reference point is movable on said target image in said image display area.

3. An image display method as claimed in claim 2, wherein a definite range of said target image, including said reference point, is displayed as said image portion in each of said partial display sections.

4. An image display method as claimed in claim 3, wherein said range is defined by the size of each of said partial display sections.

5. An image display method as claimed in claim 4, wherein the whole size of said split display window and individual sizes of said partial display sections within said split display window are changeable.

6. An image display method as claimed in claim 2, wherein said split display window is displayed overlapping said target image, so as to include said reference point therein.

7. An image display method as claimed in claim 2, further comprising steps of extracting from said target image those portions having similar colors to a color of a corresponding pixel to said reference point as target components of color correction, to display only said target components in color-corrected conditions in said partial display sections.

8. An image display method as claimed in claim 7, further comprising steps of extracting a contour of a particular component of said target image, which said pixel corresponding to said reference point belongs to, and subjecting only said component to the color-correction, to display said particular component as said target component of color correction in said partial display sections.

9. An image display method as claimed in claim 7, further comprising a step of revising, when one of said partial display sections is selected, all of those portions of said target image which correspond to said target components into such conditions as corrected based on the color correction parameter values that are allocated to said selected partial display section.

10. An image display method as claimed in claim 1, at least one of said partial display sections displays said image portion in an initial condition of said target image.

11. An image display method as claimed in claim 1, wherein positions of said partial display sections are exchangeable inside said split display window.

12. An image display method as claimed in claim 1, wherein a plural number of said split display windows may be displayed in said image display area.

13. An image display apparatus with a monitor for displaying a target image to correct in an image display area, said image display apparatus comprising:
a device for displaying a split display window in said image display area simultaneously with said target image, said split display window comprising a plural number of partial display sections; and
a device for displaying substantially the same portion of said target image in said partial display sections in such conditions as corrected based on different color correction parameter values from one another between said partial display sections.

14. An image display apparatus as claimed in claim 13, further comprising a device for designating a portion of said target image, as said image portion is to be displayed in said partial display sections.

15. An image display apparatus as claimed in claim 14, wherein said designating device comprises a device movable in said image display area in response to an external operation to select a point on said target image, a device for extracting those portions having similar colors to a color of said selected point as target components of color correction from said target image, and a device for displaying only said target components in color-corrected conditions in said partial display sections.

16. An image display apparatus as claimed in claim 15, further comprising a device for selecting one of said partial display sections, a device for displaying all of those portions of said target image which correspond to said target components in such conditions as corrected based on the color correction parameter values that are allocated to said selected partial display section

17. An image display program for activating a computer to work as a device for displaying a target image to correct in an image display area on a monitor, a device for displaying a split display window in said image display area simultaneously with said target image, said split display window comprising a plural number of partial display sections, a device for displaying substantially the same portion of said target image in said partial display sections in such conditions as corrected based on different color correction parameter values from one another between said partial display sections.
